(19) United States
(12) Patent Application Publication
(10) Pub. No.: US 2013/0200702 A1
(43) Pub. Date: Aug. 8, 2013

(54) Method for Controlling PV Installations in an Electrical Grid

(71) Applicant: Helmut Schöppner, Riedlingen (DE)

(72) Inventor: Helmut Schöppner, Riedlingen (DE)

(73) Assignee: Phoenix Contact GmbH & Co. KG, Blomberg (DE)

(21) Appl. No.: 13/805,450

(22) PCT Filed: Jun. 15, 2011
(86) PCT No.: PCT/EP2011/002937

§ 371 Date: Feb. 25, 2013

(30) Foreign Application Priority Data
Jul. 6, 2010 (DE) 10 2010 026 299.4

(51) Int. Cl. H02J 1/10

(52) U.S. Cl. CPC H02J 1/10
USPC 307/24; 307/77; 307/82

(57) ABSTRACT

In a public electric grid (30) of an energy provider, the feed-in power of photovoltaic systems (10) are controlled depending on feed-in requirements, the feed-in power of the photovoltaic systems (10) being reduced to a non-zero fraction factor (B) of the maximum possible feed-in power. The photovoltaic systems (10) each comprise a photovoltaic inverter (20) and a feed-in electricity meter (50) on the AC side (20b) of the photovoltaic inverter (20), wherein the AC side feed-in electricity meter (50) continuously measures the power actually fed into the public electric grid (30) and transmits the respective measured power data. Then, the maximum possible feed-in power of the photovoltaic systems (10) is calculated based on the fraction factor (B) and the continuously measured power data time-correlated therewith, and the feed-in remuneration for the respective photovoltaic system (10) is determined based on the thus calculated maximum possible feed-in power.

### FIELD OF THE INVENTION

The invention relates to a method for controlling photovoltaic solar systems connected to a public electric grid of an energy provider.

### BACKGROUND OF THE INVENTION

The energy demand in a public electric grid varies depending on the time of day. Therefore, in peak load times in addition to the power plants which cover the base load additional power plants are connected.

Photovoltaic solar system provide electric energy in function of the sunlight. The proportion of solar energy fed into the public electric grid is still relatively low. However, the number of distributed solar photovoltaic (PV) systems, e.g. private PV systems on house roofs or larger commercial PV systems, is continuously increasing, and thus their share of the power fed into the power grid. Therefore, at times of strong sunlight and simultaneously low energy extraction from the power grid by the consumers, the feed demands might be lower than the actual supply when all PV systems feed their current maximum possible feed-in power into the grid. This may result in problems of the electric grid.

Further, the operator of a PV system at any time attempts to feed the maximum possible energy into the electric grid, i.e. to operate his PV system with the maximum possible power at the current sunlight, and to inject this power. If, in order to reduce the total photovoltaic feed-in power into the power grid, specific photovoltaic systems would simply be shut off, this would lead to a conflict of interests between the energy provider and the operator of these PV systems, since the operator would incur financial losses and the economic efficiency of the photovoltaic system would be endangered.

### SUMMARY OF THE INVENTION

Therefore, an object of the present invention is to provide a method which with increasing feed-in power of photovoltaic solar systems into the electric grid accommodates for fluctuations of feed-in power and withdrawal power and enables the energy provider to precisely compensate the operators of photovoltaic systems for a grid-related loss of theoretically possible feed-in power.

The object of the invention is achieved by the subject matter of the independent claims. Advantageous embodiments of the invention are defined in the dependent claims.

The object of the invention is in particular achieved by proportionally driving down the photovoltaic solar systems rather than completely shutting them off. That means, the energy provider or power supply company (PSC) defines, in function of the current feed-in power and the power currently extracted from the grid, a percentage or fraction factor to which one or more photovoltaic systems are driven down. The fraction factor must not be zero, but is greater than zero but less than 100%. This ensures that despite the reduction of feed-in power each solar system still feeds measurable energy into the electric grid. Based on this continuously measured reduced feed-in energy and the fraction factor defined by the energy provider, the maximum possible feed-in power—i.e. as if the photovoltaic system would not have been driven down—may then be calculated for each time point, so that the energy provider can correctly compensate the operator of each photovoltaic system for the grid-related partial loss of feed-in remuneration.

Accordingly, the invention provides a method for controlling photovoltaic solar systems connected to a public electric grid of an energy provider, wherein a plurality of photovoltaic solar systems feed electric energy into the public electric grid. Other conventional power plants (fossil, nuclear, etc.) may be provided in the grid, especially base load power plants, that are not intended to be controlled.

The feed-in power of the photovoltaic systems are centrally controlled by the energy provider in function of the current consumption, i.e. the current feed-in demands. To this end, the energy provider defines a non-zero fraction factor B (0<B<100) depending on the feed-in requirements, and transmits the fraction factor B to the photovoltaic systems over a data connection between the photovoltaic systems and the energy provider, the photovoltaic systems comprising a controller which then automatically reduces the actual current feed-in power of this photovoltaic system to the predetermined fraction factor. For this purpose, each photovoltaic system comprises a data transmission device for establishing a data connection to the power supply company.

Each of the photovoltaic systems has a photovoltaic inverter and a calibrated feed-in electricity meter on the AC side of the photovoltaic inverter. The feed-in electricity meter of the photovoltaic system continuously measures, i.e. time-dependent and at short intervals (e.g. in seconds), the actual feed-in power as reduced to the fraction factor at the AC side and fed into the electric grid, and regularly transmits the respective measured and time-stamped power data over the data connection to a computing device of a central portal, where these data are processed and stored. The transmission of the measured power data may be effected quasi-online, or block-wise in much larger time intervals than the measurement intervals.

For calculating the feed-in remuneration for each operator of a photovoltaic system, the maximum possible feed-in power of each photovoltaic system is calculated based on the time-varying fraction factor and the continuously measured and transmitted power data time-correlated therewith, so that the feed-in remuneration for the respective photovoltaic system can be determined based on the thus calculated maximum possible feed-in power.

This enables the energy provider to centrally control the feed-in power of the photovoltaic systems connected to the power grid on the one hand, and on the other ensures that the operators of solar systems will not incur financial losses, but their maximum possible teed-in power can be calculated accurately and can be remunerated appropriately.

Preferably, the reduction of the feed-in power of each of the photovoltaic systems is accomplished by controlling the power of the photovoltaic inverter of the photovoltaic system. To this end, each photovoltaic system comprises an internal control unit. The energy provider transmits the fraction factor to the internal control units of the photovoltaic systems over a data connection, e.g. using a ripple control signal or an Internet connection or a mobile communications connection (GSM/GPRS, UMTS). In response to the receipt of the fraction factor, the internal control unit then directly controls the photovoltaic inverter, e.g. via a standard analog interface (0-4-20 mA, 0-10V), or via digital interfaces, e.g. RS232, RS485, or RS422. The energy then still actually fed into the power grid by each of the photovoltaic systems is measured by a calibrated feed-in electricity meter of the photovoltaic system. Data are collected in the internal control unit. The feed-in power is continuously measured and is transmitted by the data transmission device over a data connection to a portal of the photovoltaic system manufacturer, the operator, or a free portal, in time intervals that are optionally adjustable. These data of a plurality of photovoltaic systems are then centrally transmitted from the portal to the energy provider. The measured data are time-stamped. The fraction factor is known to the energy provider and need not necessarily be transferred, but may be transmitted if desired. The calculation of the maximum possible feed-in power may then be made by the energy provider himself. Alternatively, the calculations such as the calculation of the maximum possible feed-in power or the compensating remuneration may be performed by the computing device of the portal and transmitted to the energy provider. The energy to be remunerated is calculated based on the energy actually fed in and the fraction factor to which the inverter was reduced. These data are stored in a list in a database, and accounting will be made according to this list.

In case the data connection between one of the photovoltaic systems and the portal is interrupted, the concerned photovoltaic system automatically stores the data as continuously measured by its energy meter in a data memory of this photovoltaic system, and when the data connection is restored the stored power data are then subsequently transferred to the portal automatically, and the subsequently transferred power data are stored by the central processing device of the portal.

Each photovoltaic system typically comprises one or more strings each comprising a plurality of solar modules. In addition to the measurement of feed-in energy using the calibrated electricity meter, preferably stringwise current measurements are made on the DC side of the photovoltaic inverter of each photovoltaic system. The respective measured stringwise DC data are likewise periodically transmitted over the data connection from each photovoltaic system to the central computing device of the portal and stored therein. In case of an interruption of the data connection, the measured stringwise direct current data are also automatically saved by the photovoltaic system and then subsequently transferred automatically to the energy provider upon restoration of the data connection. The subsequently transferred direct current data are also stored by the central computing device of the portal.

The stringwise direct current data permit to determine the energy on the DC side, in addition to that of the AC side.

This enables to determine the power on the DC side and to optionally account for a poor efficiency, for example, in the calculations. Preferably, as described above, all measured data are transmitted to the portal. The DC data are likewise transmitted to the portal, and may thence be transmitted to the energy provider.

According to a simple embodiment of the invention, the photovoltaic systems each comprise a ripple control receiver, and the fractional reduction of feed-in power of the photovoltaic systems is triggered by a ripple control signal received by the ripple control receiver. Currently, the switching of electricity meters to lower tariffs is effected in this way. Therefore, advantageously, this existing infrastructure of ripple control signals may be utilized to trigger the fractional reduction of feed-in power of the individual photovoltaic systems.

Furthermore, preferably, the respective time-stamped fraction factors of the photovoltaic systems are periodically transmitted over the data connection between the photovoltaic systems and the portal to the portal and centrally stored therein. This ensures that the feed-in remuneration corrected by the fraction factor is only accounted for if the reduction of feed-in power according to the fraction factor was actually implemented by the concerned photovoltaic system.

More generally considered, the invention thus provides for an electric grid for supplying a plurality of consumers with electric energy, comprising: i) a plurality of power plants feeding into the electric grid; ii) a plurality of photovoltaic solar systems feeding into the electric grid; and iii) a plurality of consumers which are supplied with electric energy from the electric grid, wherein each of the correspondingly equipped photovoltaic solar systems comprises: i) at least one power-controllable photovoltaic inverter for converting the DC voltage generated by the photovoltaic modules into grid-compatible alternating voltage; ii) a data transmission device for establishing a data connection with the energy provider; and iii) a calibrated feed-in electricity meter on the AC side of the photovoltaic inverter. The calibrated feed-in electricity meter here is configured for periodically measuring the power actually fed into the public electric grid, and for periodically transmitting the respective measured power data. In other words, the feed-in electricity meter does not merely integrate the feed-in energy over a long period of time, but continuously measures the feed-in energy in cyclic time intervals and outputs the time-resolved measured data. These power data (measured data) and the respective associated (time-correlated) non-zero fraction factor of the maximum possible feed-in power, to which the photovoltaic system was driven down are transmitted by each photovoltaic system over the data connection to the central computing device of the portal. The computing device of the portal may then calculate, based on the fraction factor and the time-correlated power data of the respective photovoltaic system continuously measured and transmitted to the computing device of the portal, what would have been the maximum (theoretically) possible feed-in power at any time, if the photovoltaic system would not have been driven down to the fraction factor, and may determine the correct feed-in remuneration for the respective photovoltaic system based on the thus calculated maximum (theoretically) possible feed-in power.

Therefore, the calculations may be made in the portal, and the calculated maximum possible feed-in power of each photovoltaic system is then transmitted from the portal to the energy provider. But it is likewise possible that the energy provider provides the portal and performs the calculation itself.

The invention will now be described in detail by way of an exemplary embodiment and with reference to the figure.

### BRIEF DESCRIPTION OF THE FIGURE

FIG. 1 shows a schematic block diagram of an exemplary embodiment of the present invention.

### DETAILED DESCRIPTION OF THE INVENTION

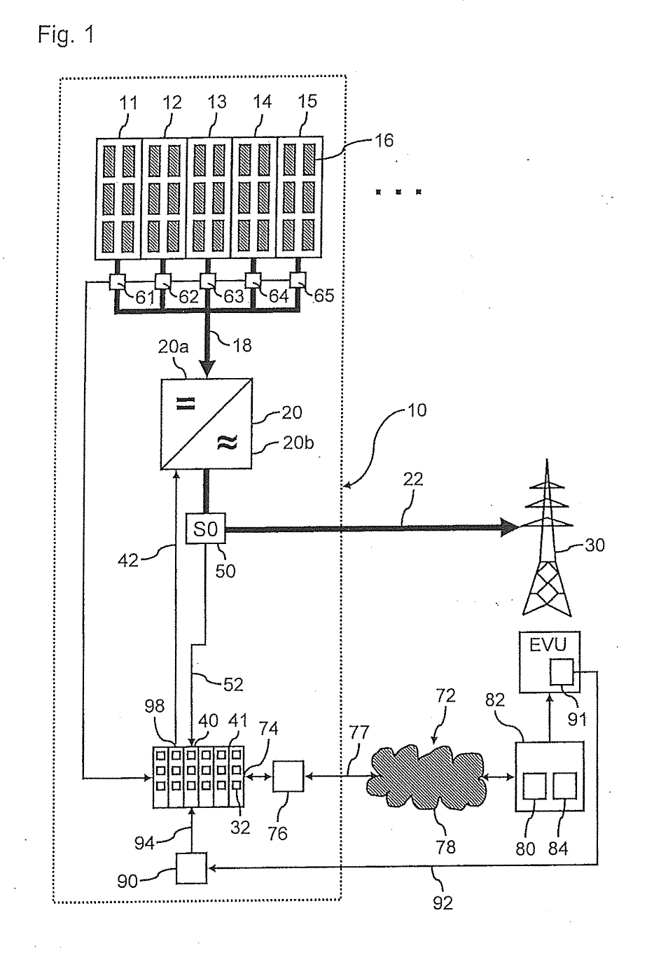

FIG. 1 shows a photovoltaic solar system 10 with five strings 11, 12, 13, 14, 15, each string comprising a plurality of solar modules 16. The five strings are connected in parallel, and the DC power therefrom is fed through DC line 18 into inverter 20 and is converted by the inverter 20 into grid-compliant AC power. Of course, the photovoltaic system may have a different number of strings. The AC voltage is then fed through line 22 into the public electric grid 30. Connected to the inverter 20 is data logger 41 of the photovoltaic system 10, which controls the inverter 20. The control line which connects the data logger 41 to the inverter is designated as 42. Data logger 41 which is provided anyway in the PV system, thus comprises the internal control unit 40 of the photovoltaic system for controlling the feed-in power.

Between inverter 20 and the feed-in point into the electric grid 30, i.e. on the AC side 20b of inverter 20, a feed-in electricity meter 50 is provided, which measures the energy fed into the power grid by the photovoltaic system. Preferably, a calibrated S0 counter 50 is used for this purpose, which transmits the measured feed-in power data over data line 52 to the control unit 40 of the photovoltaic system 10. Connected to the electric grid 30 are a plurality of photovoltaic systems 10 (only one of them being shown in FIG. 1 for the sake of simplicity).

Between the solar modules and the inverter 20, i.e. on the DC side 20a, DC meters 61, 62, 63, 64, 65 are provided, one for each string. These allow to measure the direct current supplied to inverter 20 separately for each string 11, 12, 13, 14, 15.

Both, the power data of photovoltaic system 10 measured by feed-in electricity meter 50 and the stringwise current data from DC meters 61, 62, 63, 64, 65 are collected by the internal control unit 40 of the photovoltaic system. These measured data are each provided with a timestamp and transmitted over data connection 72 to a central computing device 80 of the portal 82 to be stored and evaluated therein.

Communication between photovoltaic system 10 and portal 82 or computing device 80 is accomplished for example via an Ethernet interface 74 which is connected to the internet 78 via a DSL router 76. The communication with computing device 80 is accomplished via appropriate addresses. Alternatively, a GSM/GPRS or UMTS interface may be used, with the advantage that the cable connection 77 for data transfer from the photovoltaic system to the data network 78 may be dispensed with. For this purpose, a SIM card may be directly installed in the internal control unit 40.

Should the data connection between the internal control unit 40 and the computing device 80 of the portal 82 be interrupted, the measured data are buffered in data memory 32 of the internal control unit 40 to be relayed to the computing device 80 when the connection is restored. The measurement intervals and/or the intervals at which the data are transmitted to the portal 82 are adjustable.

Moreover, alterations in the photovoltaic system may be detected from the measured data. These may be dirt, defects, failures, or poor efficiency. Such error messages are sent from data logger 41 to the computing device 80. Also, the computing device 80 may derive other errors from the transmitted measured data.

Furthermore, the data logger 41 may be extended by additional features. For example intrusion sensors, wind measuring instruments, measuring instruments for measuring solar irradiation as well as for other physical variables (not shown) that are relevant to the operation of the photovoltaic system 10 may be connected. Moreover, data logger 41 may also be connected to an existing anti-theft system (not shown), or data logger 41 may completely accomplish the function of the anti-theft system. These data may for example provide information about why there are low levels even though the photovoltaic system was not shut down.

Furthermore, the computing device 80 may trigger other activities of data logger 41, such as retrieving a software update. Also, the computing device 80 may request direct measurements. For example, an update may be downloaded from portal 82, for adapting the interface to inverter 20, or for extending the functionality of photovoltaic system 10. Furthermore, a firmware update for the controller may be loaded remotely to respond to changes in the GSM, GPRS, or UMTS networks. Both ways allow for permanent adaptation to current situations.

The internal control unit 40 may be controlled by the energy provider via data connection 92. In particular, the power supply company, PSC, may transmit a predetermined non-zero fraction factor B (0<B<100%), e.g. 25%, to the internal control unit 40. In response thereto, the internal control unit 40 then drives the power of inverter 20 down to the fraction B, in the present example 25%.

The correct remuneration may be accomplished by a compensation payment in addition to the remuneration for the energy actually fed in. The compensation payment of the energy provider is determined as follows:

with

$$A = E \cdot V \cdot ( \frac{1}{B} - 1 )$$

A: compensation payment of the energy provider

E: energy fed in

V: feed-in tariff for solar energy

B: fraction factor

For example, E=2.5 kWh; V=0.39 Euros/kWh; B=25% result in

$$A = 2 , 5 kWh \cdot 0 , 39 / kWh \cdot ( \frac{1}{0 , 25} - 1 ) = 2 \text{,} 925$$

The maximum possible feed-in power to be remunerated results from the sum of compensation payment A and the feed-in remuneration for the energy actually fed in (E·V).

In the present example, a ripple control receiver 90 is connected to the internal control unit 40, and the photovoltaic system 10 is triggered by a ripple control signal which is received by the ripple control receiver 90 over a data connection 92. For this purpose, the fraction factor defined by the power supply company, PSC, is modulated to the ripple control signal by a ripple control transmitter 91, is transmitted to ripple control receiver 92 over the existing power line and demodulated by ripple control receiver 92. In this way, advantageously, no separate data line is required for the transmission of the fraction factor and for triggering the power reduction, since transmission is accomplished over a data connection on the power line. Control could likewise be accomplished indirectly, for example via the portal. The fraction factor is then transmitted by ripple control receiver 90 to internal control unit 40 in data logger 41, via a connecting line.

The arrow designated by reference numeral 94 indicates the direction of action of the control signal towards internal control unit 40, and the arrow designated by reference numeral 42 from internal control unit 40 to inverter 20. When ripple control receiver 90 receives a ripple control signal, the latter will be evaluated by the integrated controller. Internal control unit 40 of the photovoltaic system then controls the power of inverter 20 down to the fraction B, e.g. 25%, over control line 42. In the present example, this control is effected by an analog 4-20 mA signal. However, other interfaces 98, such as serial RS232, RS484, RS422 interfaces, Interbus, Profibus, Modbus etc., may likewise be integrated into internal control unit 40 and used for this purpose.

Inverter 20 then reduces the power fed into the electric grid 30 to the predetermined fraction factor B, e.g. 25%. The current data measured for each string and the feed-in power data measured by S0 meter 50 continue to be transmitted periodically over data connection 72 to the computing device 80 of the portal 82. These data are time-stamped and stored in a database provided in a data memory 84 of portal 82. The fraction factor B to which the inverter 20 has been driven down is stored together with these data, so that a time-resolved energy profile can be generated from these data for this photovoltaic system 10 (and for each other equally equipped photovoltaic system), i.e. the energy actually fed-in in function of time. Through time-correlation with the fraction factor B, the maximum possible feed-in power of the photovoltaic system 10 is calculated as a function of time. This function is then integrated over the remuneration period in order to determine the feed-in remuneration and compensation payment, respectively.

In the present invention, advantageously, the energy or power actually fed in is measured in the photovoltaic system 10 using a calibrated energy meter 50. The measured data are secured according to a security concept on the server side and made accessible, to prevent tampering. For accounting with the energy provider, the skilled person will use a suitable protocol which is coordinated with the energy provider.

It will be appreciated by those skilled in the art that the embodiments described above are to be understood by way of example only and that the invention is not limited to these embodiments but may be varied in many ways without departing from the spirit and scope of the invention. Furthermore, it will be apparent that the features, regardless of whether disclosed in the description, the claims, the figures or otherwise, individually define essential elements of the invention, even if they are described in combination with other features.

1. A method for controlling photovoltaic solar systems (10) connected to a public electric grid (30) of an energy provider, wherein
a plurality of photovoltaic solar systems (10) feed electric energy into the public electric grid (30),
the feed-in power of the photovoltaic systems (10) is controlled by the energy provider depending on feed-in requirements, wherein the feed-in power of the photovoltaic systems (10) is reduced (10) to a non-zero fraction factor (B) of the maximum possible feed-in power,
the photovoltaic systems (10) each comprise a photovoltaic inverter (20) and a feed-in electricity meter (50) on the AC side (20b) of said photovoltaic inverter (20), wherein said AC side feed-in electricity meter (50) continuously measures the power actually fed into the public electric grid (30), and the respective measured power data are periodically transmitted over a data connection (72) between the photovoltaic systems (10) and a portal (82) to a computing device (80) of the portal (82) to be stored therein, and
the maximum possible feed-in power of the photovoltaic systems (10) is calculated using the fraction factor (B) and the continuously measured power data time-correlated therewith, and the feed-in remuneration for the respective photovoltaic system (10) is determined based on the thus calculated maximum possible feed-in power.

2. The method as claimed in claim 1, wherein the reduction of the feed-in power of each of the photovoltaic systems (10) is effected by controlling the photovoltaic inverter (20) of the photovoltaic system (10).

3. The method as claimed in claim 2, wherein each photovoltaic system comprises a data logger (41), and the photovoltaic inverters (20) are controlled by the data logger of the respective photovoltaic system to effect the reduction of feed-in power.

4. The method as claimed in any of the preceding claims, wherein upon an interruption of the data connection (72) between one of the photovoltaic systems (10) and the portal (82), this photovoltaic system (10) automatically stores the measured power data in a data memory (32) of this photovoltaic system (10) and upon restoration of the data connection (72) subsequently automatically transfers the stored power data to the portal (82), and the subsequently transferred power data are stored by the portal (82).

5. The method as claimed in any of the preceding claims, wherein current measurements (61-65) are performed for each string on the DC side (20a) of the photovoltaic inverter (20) of each photovoltaic system (10), and the respective measured direct current data are periodically transmitted over the data connection (72) between the photovoltaic systems (10) and the portal (82) from the photovoltaic systems (10) to the central computing device (80) of the portal (82) to be stored therein.

6. The method as claimed in claim 5, wherein upon an interruption of the data connection (72) between one of the photovoltaic systems (10) and the portal (82), this photovoltaic system (10) automatically stores the measured direct current data in the data memory (32) of this photovoltaic system (10) and upon restoration of the data connection (72) subsequently automatically transfers the stored direct current data to the portal (82), and the subsequently transferred direct current data are stored by the portal (82).

7. The method as claimed in any of the preceding claims, wherein each of the photovoltaic systems (10) comprises a ripple control receiver (90), and wherein the fractional reduction of feed-in power of the photovoltaic systems (10) is triggered by a ripple control signal (92) received by said ripple control receiver (90).

8. The method as claimed in any of the preceding claims, wherein the fraction factors (B) of the photovoltaic systems (10) are each time-stamped and transmitted over the data connection (72) between the photovoltaic systems (10) and the portal (82) to the portal (82) and centrally stored therein.

9. An electric grid (30) for supplying a plurality of consumers with electric energy, comprising a plurality of power plants feeding into the electric grid (30), a plurality of photovoltaic solar systems (10) feeding into the electric grid (30), a plurality of consumers which are supplied with electric energy from the electric grid (30), and a central portal (82),
wherein each of the photovoltaic solar systems (10) comprises:
at least one photovoltaic inverter (20) for converting the DC voltage (18) generated by the photovoltaic modules (16) into grid-compatible alternating voltage;
a data transmission device (74, 76, 77) for establishing a data connection (72) with the portal (82);
a feed-in electricity meter (50) on the AC side (20b) of the photovoltaic inverter (20), adapted for continuously measuring the power actually fed into the public electric grid (30) and for periodically transmitting the respective measured power data over the data connection (72) to a central processing device (80) of the portal (82);
an internal control unit (40) for controlling the power of the respective photovoltaic system (10);
wherein the energy provider is connected to the photovoltaic systems (10) by a data connection (92) and transmits a feed-in requirement depending non-zero fraction factor (B) to the internal control units (40) of the photovoltaic systems;
wherein the internal control units (40) reduce the feed-in power of the respective photovoltaic system (10) to the non-zero fraction factor (B); and
wherein the maximum possible feed-in power of each of the photovoltaic systems (10) is calculated using the fraction factor (B) and the continuously measured power data time-correlated therewith and transmitted to the computing device (80) of the portal (82), and wherein the feed-in remuneration for the respective photovoltaic system (10) is determined based on the thus calculated maximum possible feed-in power.

10. A photovoltaic solar system (10) for connection to a public electric grid (30) of an energy provider, comprising:
one or more strings (11-15) each comprising a plurality of solar modules (16);
at least one power-controllable photovoltaic inverter (20) for converting the DC voltage (18) generated by the solar modules (16) into grid-compatible AC voltage;
a data transmission device (74, 76, 77) for establishing a data connection (72) with a portal (82);
an internal control unit (40) adapted for controlling the power of the photovoltaic inverter (20) to a non-zero fraction factor (B) received from the energy provider;
a feed-in electricity meter (50) on the AC side (20b) of the photovoltaic inverter (20) adapted for continuously measuring the power actually fed into the public electric grid (30) and for periodically transmitting the respective measured power data over the data connection (72) to a central processing device (80) of the portal (82).
